(19) United States
(12) Patent Application Publication
(10) Pub. No.: US 2021/0170626 A1
(43) Pub. Date: Jun. 10, 2021

(54) ALTERNATIVE USES OF FOOD PROCESSING BY-PRODUCTS

(71) Applicant: Ana Maria SANTOS LIMA, Porto (PT)

(72) Inventor: Ana Maria SANTOS LIMA, Porto (PT)

(21) Appl. No.: 16/645,304

(22) PCT Filed: Sep. 17, 2018
(86) PCT No.: PCT/IB2018/057109

§ 371 Date: Mar. 6, 2020

(30) Foreign Application Priority Data
Sep. 15, 2017 (PT) 110291

(51) Int. Cl. B27N 3/00; B09B 3/00; B27N 1/02; B27N 3/02; B27N 3/08; B29C 43/00; B29C 43/02; B29C 43/52; B29C 35/08; C08L 99/00; C08L 97/02; C08L 97/00

(52) U.S. Cl. CPC B27N 3/007; B29K 2105/26; B27N 1/02; B27N 3/02; B27N 3/002; B27N 3/08; B29C 43/003; B29C 43/02; B29C 43/52; B29C 35/0805; C08L 99/00; C08L 97/02; C08L 97/007; B29C 2035/0861; B09B 3/0033

(57) ABSTRACT

The present application relates to a product made with food processing by-products/wastes in particular from the cocoa and chocolate industry, the coffee roasting industry, the wine and distillery industries, the beer industry, the olive oil industry and the fruits and vegetables industries, mixed with a binder, preferably a bio-based binder. The present application also relates to the method of manufacturing the product.

### TECHNICAL DOMAIN

The present application relates to a product made with food processing by-products/wastes, in particular from the cocoa and chocolate industry, coffee roasting industry, wine and distillery industry, beer industry, olive oil industry and fruits and vegetables industries, mixed with a binder, preferably a bio-based binder.

The present application also discloses the method of manufacturing the product and its uses.

### SUMMARY

The present application relates to a product comprising:
75-95% (w/w) of food processing by-products/wastes chosen from the following list: cocoa hulls, coffee silverskin or coffee chaff and defective beans, grape stalks, grape pomace or marc and exhausted grape marc, brewers spent grain, olive husks and olive pomace, tomato pomace and citrus pulp or mixtures thereof;
binder in a proportion of 5 to 25% of binder to 75 to 95% (w/w) of food processing by-products/wastes on a dry basis, in which the binder is bio based derived from natural sources, a polymer or co-polymer;
in which the product has a size: 1200-2500 and 600-1250 mm, a thickness: 5-100 mm, density: 500-1200 kg/m³, internal bond: 0.4-2.5 N/mm², moisture content (%): 2-10%, modulus of elasticity (N/mm²): 1000-4000, swelling in thickness 24 h (%): 5-30.

In one embodiment the food processing by-products/wastes are mixed with wood particles or wood by-products.

In one embodiment the food processing by-products/wastes are mixed or layered with cork or cork waste/by-products.

In another embodiment the binder is used in solid state, a powder or an aqueous solution.

In yet another embodiment the bio based binder is selected from different natural products such as starch, protein from soya, lignin, tannins, cellulose, mineral oils, chitosan, casein, natural rubber, among others or combinations of them or their nanoparticles.

In one embodiment binder is a polymer or co-polymer binder selected from esters from acrylic acid; carboxylic acid; poly urethane ester; poly urethane ether; acrylic acid neutralized; polyvinyl acetate; unsaturated polyester/polyether and polyisocyanate.

In another embodiment the binder is an aqueous dispersion based on nanocomposites derived from esters of acrylic acid/styrene/ethylene/polyacetate vinyl, ether-ester of polyurethane.

In one embodiment the binders are epoxy resins.

In one embodiment the binder comprises polymeric particles.

In another embodiment the binder is extracted from the food processing by-products themselves.

In one embodiment the product further comprises cross linking agents such as salts, zinc oxide, anionic polymers, oxiranes, diamines, in an amount between 0.1 and 5% (w/w) on the dry basis of the by-product/wastes.

In another embodiment the product further comprises additives such as waxes, fungicides, flame retardants like natural oils, paraffins, mineral salts, zinc oxide, ammonia, sodium salts, amines, silica, polysiloxane, silicone, starch and possible combinations of them, in an amount between 1 and 15% (w/w) on the dry basis of the by-product/wastes.

The present application also relates to a method of producing the product comprising the following steps:
collecting the food processing by-products;
conditioning of the food processing by-products/wastes;
selection of the food processing by-products/wastes according to the desired characteristics for the final product, from cocoa hulls, coffee silverskin or coffee chaff and defective beans, grape stalks, grape pomace or marc and exhausted grape marc, brewers spent grain, olive husks and olive pomace, tomato pomace and citrus pulp or mixtures thereof;
mixing the food processing by-products/wastes with a binder, for 2 to 30 minutes, between 50 to 2000 rpm until the mixture is homogenized;
transferring the mixture into a press;
hot-pressing step;
removing the product from the press;
allowing the product to cool down at a temperature between 15° C. to 35° C.;
finishing the product with any finishing technique;
storing the product in normal storage conditions.

In one embodiment the method further comprises a drying step of the food processing by-products/wastes before the step of mixing with the binder.

In one embodiment the binder is added in a proportion of 5 to 25% of binder to 75 to 95% (w/w) of food processing by-products/wastes on a dry basis.

In another embodiment cross linking agents are added to the mixture in an amount between 0.1 and 5% (w/w) on the dry basis of the by-products/wastes.

In yet another embodiment additives are added to the mixture in an amount between 1 and 15% (w/w) on the dry basis of the by-products/wastes.

In one embodiment hot pressing step occurs between 70 and 200° C. and a pressure between 100 and 25000 KPa, during 1 to 20 minutes.

In another embodiment the mixture is transferred into a mold and said mold is then transferred into the press.

In yet another embodiment the finishing step of the method comprises the techniques of sanding, varnishing, waxing, coating, and polishing of the final product.

In one embodiment High Frequency or Radio Frequency heating is applied during the hot-pressing step.

In one embodiment the product herein described can be a panel, a board, a block, a tile, an acoustic sheet or tile, a pavement mosaic, a wall mosaic, a ceiling mosaic, a decorative element, furniture, packaging, a household product, a fashion accessory, a car component, or any other deemed suitable.

### STATE OF THE ART

This application is aligned with the global government priorities, policies and projects towards zero waste strategies and the implementation of a circular economy as “an industrial system that is restorative or regenerative by intention and design. It replaces the “end-of-life” concept with restoration, shifts towards the use of renewable energy, eliminates the use of toxic chemicals, which impair reuse and aims for the elimination of waste through superior design of materials, products, systems and, within this, business models” [1]. There is a consensus voice from researchers and different public entities about recovery of materials from end-life products:

“The biomass-based byproducts and residues from agro-food industries are usually considered to be widespread, cheap and readily available resources. They may even constitute an environmental problem thus imposing an economic burden on these industries.” [2].

### GENERAL DESCRIPTION

Each year, agri-food industries produce large amounts of waste, which are often discarded. Only a minor percentage goes to other destinations, like animal feed or composting.

The present application relates to an alternative use of food processing by-products/wastes as raw materials to produce new products, in particular from the cocoa and chocolate industry, coffee roasting industry, wine and distillery industry, beer industry, olive oil industry and fruits and vegetables industries.

Disclosed herein are also formaldehyde-free binders which comprise bio-based binders.

This application also relates to the production method of the product and its uses.

There is not yet a common worldwide recognized definition of food waste. The European project FUSIONS [3] has worked in order to provide a definitional framework for food waste to harmonize the current definition within the EU. The final definition proposed in 2014 was “Food waste is any food, and inedible parts of food, removed from the food supply chain to be recovered or disposed (including composted, crops ploughed in/not harvested, anaerobic digestion, bio-energy production, co-generation, incineration, disposal to sewer, landfill or discarded to sea)”. According to this definition, the food processing residues disclosed herein that are destined to one of the recovering or disposing actions included in the FUSION's definition are classified as food waste.

This seems, apparently in contradiction with the Waste Framework Directive (EU waste management law, Directive 2008/98/CE) which specifies that the “by-product is a substance or object, resulting from a production process, the primary aim of which is not the production of that item.” And that, unlike waste, it must be able to be used afterward. Following the WFD, the European Commission, in 2012, elaborated a Guidance on the interpretation of key provisions of the Directive underlining, for example, the meaning of the conditions that must be cumulatively met by a residue to be effectively a by-product:
must be usable again in the same production process or in a next production or utilization process and, above all, the further use must be certain;
must be directly reusable without any further treatment other than normal industrial practice;
it is produced as an integral part of a production process;
the final further use must be lawful, that is, the product fulfils all relevant product, environmental and health-protection requirements for the specific use and will not lead to overall negative impacts on human health or environment.

The uses further reported in the present application authorize, in principle, the definition of this food processing residues as by-products.

A circular economy is an alternative to the traditional linear economy, which relies on making, using and throwing away products often produced using virgin materials. It generates environmental benefits, that include a reduction of the impacts of the extractive and primary industries and the avoidance of end-of-life impacts of waste production and management.

The present application is aligned with the European Commission's Circular Economy Package: it contributes to a closed loop society, by up-cycling the solid organic waste generated from the production process of the most consumed, and continuously produced, food and beverages turning them into valuable and unique products. While stimulating industrial symbiosis, turning one industry's byproduct into another industry's raw material. Creating greener products that can avoid the depletion of precious resources of our planet. The product disclosed herein can extend the life-cycle of existing materials and reduce the constraint on virgin resources, by being used as a substitute material for wood pulp, especially in the manufacturing, design and construction usage. The product disclosed herein offer a fresh alternative to traditional materials, with differentiated properties and environmental sustainability, which can also provide a wider range of imaginative design opportunities, with thousands of product applications, ranging from architecture and interior design, walls, floors and ceilings, furniture, packaging and household and consumer products.

Using the production waste from agri-food industries to make new materials, the product herein disclosed informs the end customer of its raw materials provenance and the life-cycle of the products consumed daily. It meets the needs of a new generation of consumers in constant pursuit of differential products, ones with meaning and authenticity. It offers them the opportunity to connect and engage with products they already know and love in new and unusual ways.

The strength of the present application lies in its holistic narrative, transforming the waste of well-known products into aesthetic and functional materials, with interesting properties of moisture resistance, structural performance, thermal and acoustic insulation and durability.

To agro-food industries, the products that result from the technology herein disclosed create business value. It helps agro-food companies to tell their consumers the story of their company in a circular economy implementation. It brings economic and environmental value to the solid organic waste these companies produce, giving them another way to put their sustainability goals into practice.

To high-end architectural products distributors, architects and designers the present application creates new materials for their portfolio: sustainable and with a unique texture; that offer a multi-sensory experience.

The product obtained according to the present application has:

Standard size: 1200-2500 and 600-1250 mm

Standard thickness: 5-100 mm

Density: 500-1200 kg/m³

Internal bond: 0.4-2.5 N/mm²

Moisture content (%): 2-10%

Modulus of elasticity (N/mm²): 1000-4000

Swelling in thickness 24 h (%): 5-30

Said product can be, in a non-exhaustive list: a panel, a board, a block, a tile, an acoustic sheet or tile, a pavement mosaic, a wall mosaic, a ceiling mosaic, a decorative element, furniture, packaging, a household product, a fashion accessory, a car component, or any other deem suitable.

In one embodiment the method of producing a product comprises the steps of:
collecting the food processing by-products/wastes;
conditioning of the by-products/wastes;
selecting the by-products/wastes according to the desired characteristics of the final product;
mixing the by-products/wastes with the binder until homogenized;
transferring the mixture into a press;
hot-pressing step;
allowing the product to cool down at room temperature;
finishing the product with any possible finishing;
storing the product in normal storage conditions.

### BRIEF DESCRIPTION OF DRAWINGS

The present technology is illustrated by way of example, and not by way of limitation, in the FIGURE of the accompanying drawings.

FIG. 1 illustrates a schematic representation of the method to produce the product herein described.

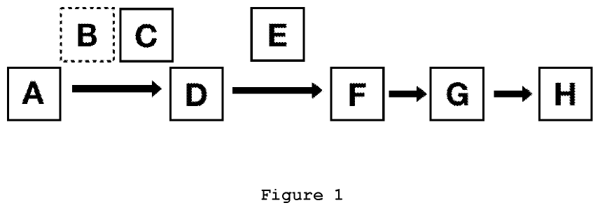

In the first step A, food processing by-products/wastes are collected. This collected food processing by-products may be: cocoa hulls, coffee silverskin or coffee chaff and defective beans, grape stalks, grape pomace or marc and exhausted grape marc, brewers spent grain, olive husks and olive pomace, tomato pomace and citrus pulp or mixtures thereof. Then, in the second step B, some of this food processing by-products may have to be dried, according to the third step, C, where the said by-products are chosen according to the desired characteristics of the final product. In the fourth step D, the food-processing by products are mixed with the binder. The amount (and type) of binder may be conveniently chosen in dependence of what kind of product is to be produced by the method according to the invention. In the fifth step, E, the mixture is placed in a preheated press or mould. In the sixth step F, the mixture is pressed in the desired press. In the seventh step G, the product is removed from the press and is given, on the eighth step H, the desired finish.

### DETAILED DESCRIPTION

The present application relates to an alternative use of food processing by-products/wastes as raw-materials in the manufacturing of a new product, in particular from the cocoa and chocolate industry, such as cocoa hulls, coffee roasting industry, such as coffee silverskin or coffee chaff and defective beans, wine and distillery industry, such as grape stalks, grape pomace or marc and exhausted grape marc, beer industry, such as brewers spent grain, olive oil industry, such as olive husks and olive pomace, fruits and vegetables industries, such as tomato pomace and citrus pulp.

Food processing by-products/wastes are chosen according to the desired characteristics for the final product. They are chosen from the following list: cocoa hulls, coffee silverskin or coffee chaff and defective beans, grape stalks, grape pomace or marc and exhausted grape marc, brewers spent grain, olive husks and olive pomace, tomato pomace and citrus pulp.

The product obtained from the method described herein comprise 75-95% (w/w) of food processing by-products/wastes and a binder which can be bio based, derived from natural sources, a polymer or co-polymer.

In one embodiment the by-product/wastes are further mixed with wood particles or wood by-products. In another embodiment the by-product/wastes are further layered with wood particles or wood by-products.

In one embodiment the food processing by-products/wastes are mixed with cork or cork waste/by-products. In another embodiment the by-product/wastes are further layered with cork or cork waste/by-products.

In one embodiment the food processing by-products/wastes are used alone. In another embodiment the food processing by-products/wastes are intermixed.

The binder is added in a proportion of 5 to 25% of binder to 75 to 95% (w/w) of food processing by-products/wastes, on a dry basis.

The binder can be used in solid state, a powder or an aqueous solution. In a preferred embodiment, the binder is a powder. The binder used in powder has proven to be a very interesting choice to use in the product herein disclosed because it avoids the introduction of more water, coming from the binder, and allows the food processing by-products/wastes to have a higher moisture level in the process.

The choice of the binder, and optional crosslinking agents, is based on the mechanical and chemical properties that are required for the product and its application. The binder is also selected taking in consideration the chosen food processing by-product/wastes.

In an embodiment the binders are bio based and derived from different natural resources. These bio binders are selected from different natural products such as starch, protein from soya, lignin, tannins, cellulose, mineral or vegetable oils, chitosan, casein, natural rubber among others or combinations of them or their nanoparticles.

The binders can also be polymers or co-polymers. In one embodiment the polymer or co-polymer binders are selected from a list of: esters from acrylic acid; carboxylic acid; poly urethane ester; poly urethane ether; acrylic acid neutralized; polyvinyl acetate; unsaturated polyester/polyether and polyisocyanate but not restricted to them.

In one embodiment the binder has one morphology or chemical composition, or combined morphologies.

In one embodiment the binder comprises polymeric particles. In another embodiment the binder comprises polymeric particles selected from the following list: aqueous dispersion from one polymer or co-polymer based on acrylic acid esters or carboxylic acids combined with poly urethane (PUPA), in which the polymeric particles size varies between 40 and 400 nm, and the solid content is within 20 and 100% (m/m) and the molecular weight is between 500 and 10.000 g/mol.

In one embodiment the binder is an aqueous dispersion, based on polyurethane ester or ether in which the polymeric particles size varies between 40 and 400 nm, and the solid content is within 20 and 100% (m/m) and the molecular weight is between 500 and 10.000 g/mol.

In another embodiment the binder is an aqueous dispersion based on nanocomposites derived from esters of acrylic acid/styrene/ethylene/polyacetate vinyl, ether-ester of polyurethane, also possibly combined with inorganic compounds, such as silica, with particles size less than 90 nm.

In yet another embodiment the binder is extracted from the food processing by-products/wastes themselves.

In another embodiment the binders are epoxy resins, with the addition of crosslinking agents.

In one embodiment the bio binders, in a polymeric state or not, need to be activated to react with temperature by a crosslinking agent that can also be natural and developed from wastes/food processing by-products.

In one embodiment the product further comprises crosslinking agents to improve the physical and mechanical properties of the final product. They are introduced with the binder itself or immediately after the addition of the binder in an amount from 0.1 to 5% on the dry basis of the by-products/wastes (w/w).

Crosslinking agents can be of various types, like salts, zinc oxide, anionic polymers, oxiranes and diamines.

In another embodiment additives, such as waxes, fungicides, flame retardants like natural oils, paraffins, mineral salts, zinc oxide, ammonia, sodium salts, amines, silica, polysiloxane, silicone, starch and possible combinations of them are added to change the properties of the product, such as resistance to water, retardancy to fire or resistance to fungi or bacterial attack. These are also added after the mixture with the binder and in percentages that varies from 1 to 15% on the dry basis of the by-product/waste (w/w).

The method of producing the product described in the present application comprises the steps of:
collecting the food processing by-products;
conditioning of the food processing by-products/wastes;
selection of the food processing by-products/wastes according to the desired characteristics for the final product, from cocoa hulls, coffee silverskin or coffee chaff and defective beans, grape stalks, grape pomace or marc and exhausted grape marc, brewers spent grain, olive husks and olive pomace, tomato pomace and citrus pulp or mixtures thereof;
mixing the food processing by-products/wastes with a binder, for 2 to 30 minutes, between 50 to 2000 rpm until the mixture is homogenized;
transferring the mixture into a press;
hot-pressing step;
removing the product from the press;
allowing the product to cool down at a temperature between 15° C. to 35° C.;
finishing the product with any finishing technique;
storing the product in normal storage conditions.

In one embodiment the method further comprises the application of High Frequency or Radio Frequency Heating during the hot-pressing step. For the production of the product herein disclosed, Radio Frequency heating technology advantages include the production in molds, which opens up new possibilities and final applications; also providing uniformity of heating and moisture leveling, rapid heating and drying it enhances the uniformity of the density of the product from surface to surface and the result is a better internal bond. Because of these advantages, it is also possible to reduce the press cycle, the platens temperature and the post-curing time, with constancy of resin formulation, which brings benefits concerning the productivity of the operation.

The hot-pressing step can be made in various types of presses, namely opening presses, continuous presses, radio frequency or high frequency hot-presses or vacuum presses, but is not limited to the ones described herein.

The hot-pressing step occurs between 70 and 200° C. and a pressure between 100 and 25000 kPa, during 1 to 20 minutes according to the desired thickness. In this step the mixture of by-products/wastes and binder is pressed in order to achieve the final product.

The pressure in the hot-pressing step is changed depending on the selected binder or the desired mechanical properties of the final product.

In one embodiment, for smaller dimension products, between 100-500 mm, the mixture of food-processing by-products with the binder is transferred into a mold, that can be flat or of any shape, that is then transferred into the press to achieve the final product.

The mixture, when pressed, assumes a decorative effect, true to the original state of the food-processing by-products/wastes as collected, since they are used raw and unprocessed as no change is made into their particle size, color or natural smell, so the final product maintains a natural smell and texture.

In a preferred embodiment the mixture is pressured to obtain a thickness from 5 to 100 mm and a density between 500 and 1200 kg/m³.

In one embodiment the method comprises a drying step of the food processing by-products/wastes before mixing said by-product with the binder, in order to obtain a moisture level between 3 and 11%, weight on a dry basis.

The time and velocity of the mixing is determined by the nature of the mixture, particularly by the dimension of the polymeric particles of the binder and their sensitivity to mechanical impact.

The binder is added in a proportion of 5 to 25% of binder to 75 to 95% of food processing by-products/wastes on a dry basis.

In one embodiment, crosslinking agents are further added to the mixture. Crosslinking agents are added to the mixture in an amount between 0.1 and 5% (w/w) on the dry basis of the by-product/waste.

In another embodiment additives are added to the mixture in an amount between 1 and 15% (w/w) on the dry basis of the by-product/waste.

In another embodiment the finishing step of the method comprises, but is not limited to, sanding, varnishing, waxing, coating, and polishing the product.

The product herein disclosed can be totally biodegradable, according to the matrix used in their manufacturing.

The product obtained according to the present application has:

Standard size: 1200-2500 and 600-1250 mm;

Standard thickness: 5-100 mm;

Density: 500-1200 kg/m³;

Internal bond: 0.4-2.5 N/mm²;

Moisture content (%): 2-10%;

Modulus of elasticity (N/mm²): 1000-4000;

Swelling in thickness 24 h (%): 5-30.

The product herein described can be a panel, a board, a block, a tile, an acoustic sheet or tile, a pavement mosaic, a wall mosaic, a ceiling mosaic, a decorative element, furniture, packaging, a household product, a fashion accessory, a car component, or any other deemed suitable.

This description is of course not in any way restricted to the forms of implementation presented herein and any person with an average knowledge of the area can provide many possibilities for modification thereof without departing from the general idea as defined by the claims. The preferred forms of implementation described above can obviously be combined with each other. The following claims further define the preferred forms of implementation.
[1] Towards the Circular Economy: Economic and business rationale for an accelerated transition, 2012, Ellen MacArthur Foundation.
[2] Os subprodutos agro-industriais de natureza lenhoceculósica, Luis C. Duarte, M. Paula Esteves, Florbela Carvalheiro, Paula Vicente, Franciso M. Girio Departamento de Biotecnologia, UFMBT, INETI, 2007.
[3] www.eu-fusions.org

1. A product comprising:
75-95% (w/w) of a food processing by-products/wastes selected from the group consisting of: cocoa hulls, coffee silverskin or coffee chaff and defective beans, grape stalks, grape pomace or marc and exhausted grape marc, brewers spent grain, olive husks and olive pomace, tomato pomace, citrus pulp and mixtures thereof; and
a binder in a proportion of 5 to 25% the to 75 to 95% (w/w) of food processing by-products/wastes on a dry basis, in which the binder is bio based derived from natural sources, a polymer or co-polymer;
in which the product has a size: 1200-2500 and 600-1250 mm, a thickness: 5-100 mm, density: 500-1200 kg/m³, internal bond: 0.4-2.5 N/mm², moisture content (%): 2-10%, modulus of elasticity (N/mm²): 1000-4000, swelling in thickness 24 h (%): 5-30.

2. The product according to claim 1, wherein the food processing by-products/wastes is mixed or layered with wood particles or wood waste or by-products.

3. The product according to claim 1, wherein the food processing byproducts/wastes is mixed or layered with cork or cork waste/by-products.

4. The product according to claim 1, wherein the binder is a solid state, a powder or an aqueous solution.

5. The product according to claim 1, wherein the bio based binder is selected from the group consisting of starch, protein from soya, lignin, tannins, cellulose, mineral oils, chitosan, casein, natural rubber, combinations thereof and nanoparticles thereof.

6. The product according to claim 1, wherein the polymer or co-polymer binder is selected from the group consisting of esters from acrylic acid, carboxylic acid, poly urethane ester, poly urethane ether, acrylic acid neutralized, polyvinyl acetate, unsaturated polyester/polyether and polyisocyanate.

7. The product according to claim 1, wherein the binder is an aqueous dispersion based on nanocomposites derived from esters of acrylic acid/styrene/ethylene/polyacetate vinyl, ether-ester of polyurethane.

8. The product according to claim 1, wherein the binders is an epoxy resin.

9. The product according to claim 1, wherein the binder comprises polymeric particles.

10. The product according to claim 1, wherein the binder is extracted from the food processing by-products.

11. The product according to claim 1, further comprising cross linking agents selected from the group consisting of salts, zinc oxide, anionic polymers, oxiranes, diamines, in an amount between 0.1 and 5% (w/w) on the dry basis of the by-product/wastes.

12. The product according to claim 1, further comprising additives selected from the group consisting of waxes, fungicides, flame retardants like natural oils, paraffins, mineral salts, zinc oxide, ammonia, sodium salts, amines, silica, polysiloxane, silicone, starch and combinations thereof, in an amount between 1 and 15% (w/w) on the dry basis of the by-product/wastes.

13. The product according to claim 1, wherein said product is a panel, a board, a block, a tile, an acoustic sheet or tile, a pavement mosaic, a wall mosaic, a ceiling mosaic, a decorative element, furniture, packaging, a household product, a fashion accessory, or a car component.

14. A method of producing the product described in claim 1, comprising the following steps:
collecting the food processing by-products;
conditioning the food processing by-products/wastes;
selecting the food processing by-products/wastes according to the desired characteristics for the final product, from cocoa hulls, coffee silverskin or coffee chaff and defective beans, grape stalks, grape pomace or marc and exhausted grape marc, brewers spent grain, olive husks and olive pomace, tomato pomace and citrus pulp or mixtures thereof;
mixing the food processing by-products/wastes with a binder, for 2 to 30 minutes, between 50 to 2000 rpm until the mixture is homogenized;
transferring the mixture into a press;
hot-pressing step;
removing the product from the press;
allowing the product to cool down at a temperature between 15° C. to 35° C.;
finishing the product with any finishing technique; and
storing the product in normal storage conditions.

15. The method according to claim 14, wherein it further comprises a drying step of the food processing by-products/wastes before the step of mixing with the binder.

16. The method according to claim 14, wherein the binder is added in a proportion of 5 to 25% of binder to 75 to 95% (w/w) of food processing by-products/wastes on a dry basis.

17. The method according to claim 14, wherein cross linking agents are added to the mixture in an amount between 0.1 and 5% (w/w) on the dry basis of the by-products/wastes.

18. The method according to claim 14, wherein additives are added to the mixture in an amount between 1 and 15% (w/w) on the dry basis of the by-products/wastes.

19. The method according to claim 14, wherein the hot pressing step occurs between 70 and 200° C. and a pressure between 100 and 25000 KPa, during 1 to 20 minutes.

20. The method according to claim 14, wherein the mixture is transferred into a mold and said mold is then transferred into the press.

21. The method according to claim 14, wherein the finishing step of the method comprises the techniques of sanding, varnishing, waxing, coating, and polishing of the final product.

22. The method according to claim 14, wherein High Frequency or Radio Frequency heating is applied during the hot-pressing step.
